(19) United States
(12) Patent Application Publication
(10) Pub. No.: US 2024/0381964 A1
(43) Pub. Date: Nov. 21, 2024

(54) ASSISTED COMBINER BREAKAWAY SYSTEMS AND METHODS FOR PILOT SAFETY AND CERTIFICATION

(71) Applicant: Rockwell Collins, Inc., Cedar Rapids, IA (US)

(72) Inventor: James Anthony Geyer, Newberg, OR (US)

(21) Appl. No.: 18/199,032

(22) Filed: May 18, 2023

(51) Int. Cl. A42B 3/04; G02B 27/01

(52) U.S. Cl. CPC A42B 3/042; G02B 27/0176

(57) ABSTRACT

A combiner includes an active breakaway mechanism. The breakaway mechanism includes a biasing element to positively direct the breakaway mechanism to a safe state, and a release element. In the event of a crash, the release element disengages, and the biasing element pushes the combiner into a safe orientation. A processor and detection element may detect a crash event and actuate the release element. The biasing element may be hydraulic, a spring, a linear actuator, or the like. The release element may include a solenoid, electromagnet, spring, compressed gas, expanding gas, or the like.

### BACKGROUND

Current combiner breakaway mechanisms are passive: they rely on inertia or the kinetic energy of the combiner to move the combiner into a safe position, or more dangerously intentionally take a head strike by the pilot, in the event of a crash. Such designs have difficulty satisfying crash safety criteria, while still meeting mechanical and optical performance goals. Furthermore, passive breakaway mechanisms present certification risks: every unique design has to be individually tested and certified. Even very minor changes to the system can result in drastic impacts to the operation of the breakaway mechanism.

Future, lightweight combiner designs will only exacerbate the problem. It would be advantageous to have a combiner that satisfied performance criteria with superior safety features.

### SUMMARY

In one aspect, embodiments of the inventive concepts disclosed herein are directed to a combiner with an active breakaway mechanism. The breakaway mechanism includes a biasing element to positively direct the breakaway mechanism to a safe state, and a release element. In the event of a crash, the release element disengages, and the biasing element pushes the combiner into a safe orientation.

In a further aspect, the biasing element may be hydraulic, solenoid, compressed gas, pyrotechnic, a spring, a linear actuator, or the like. The release element may include a hydraulic, solenoid, electromagnet, spring, compressed gas, expanding gas, pyrotechnic, or the like.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a perspective view of a combiner element according to an exemplary embodiment;

FIG. 2 shows a system suitable for implementing an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a combiner with an active breakaway mechanism. The breakaway mechanism includes a biasing element to positively direct the breakaway mechanism to a safe state, and a release element. In the event of a crash, the release element disengages, and the biasing element pushes the combiner into a safe orientation. The biasing element may be hydraulic, solenoid, compressed gas, pyrotechnic, a spring, a linear actuator, or the like. The release element may include a hydraulic, solenoid, electromagnet, spring, compressed gas, expanding gas, pyrotechnic, or the like.

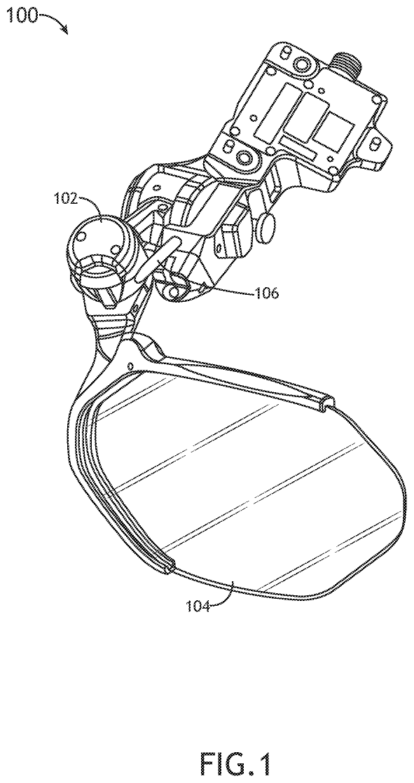

Referring to FIG. 1, a perspective view of a combiner element 100 according to an exemplary embodiment is shown. The combiner element 100 includes an active breakaway mechanism 102. Traditionally, combiners elements 100 are placed in front of the pilot during normal operation and include passive breakaway mechanisms that move the optical combiner 104 away from the user in the event of a crash. The active breakaway mechanism 102 includes a biasing element 106 that actively moves the optical combiner 104 from an operational state (as shown in FIG. 1) to a safe state with the optical combiner 104 away from the user's eye.

In at least one embodiment, the biasing element 106 may comprise an element activated when a crash event is detected. For example, the biasing element 106 may comprise an electric solenoid, an expanding gas mixture (e.g. sodium azide (NaN₃), KNO₃, and SiO₂), an electromagnet, or a motor/servo. In such embodiments, the combiner element 100 may include at least one processor and sensor for detecting a crash event (such as an accelerometer). Alternatively, or in addition, the combiner element 100 may be in data communication with a separate processor and sensor; the separate processor and sensor communicate a crash event to the combiner element 100 to actuate the biasing element 106.

In at least one embodiment, the biasing element 106 may comprise an energy storage element such as a spring or compressed gas cylinder. When a user puts the optical combiner 104 into an operational state, energy is stored in the biasing element 106 to provide sufficient energy to actively transition the optical combiner 104 back to a safe state in the event of a crash. The active breakaway mechanism 102 includes a release element. When the optical combiner 104 is placed in the operational state, and energy stored in the biasing element 106, the release element is engaged to keep the optical combiner in the operational state and retain the energy stored in the biasing element 106.

The release element may include an electrical component (such as an electromagnet, motor/servo, or electric solenoid), a chemical component (such as a pyrotechnic bolt or expanding gas mixture), or a physical component (such as a weighted pendulum, spring, or compressed gas cylinder). The release element may be controlled by at least one processor and sensor for detecting a crash event (such as an accelerometer). Alternatively, or in addition, the combiner element 100 may be in data communication with a separate processor and sensor; the separate processor and sensor communicate a crash event to the combiner element 100 to actuate the release element.

A biasing element 106 with an active actuation method pushes or adds a force to the optical combiner to push it out of the way. Alternatively, a biasing element 106 may store energy for release by an active release element that removes a force holding the optical combiner in place so the biasing element 106 may push it. In at least one embodiment, the biasing element 106 or release element may be initially actuated via inertia of the optical combiner 104.

Embodiments of the present disclosure allow an optical combiner to be safely actuated into breakaway in any and all crash scenarios via an active system when a crash event is detected (such as exceeding a permissible G limit for the airframe). By assisting the optical combiner into a safe position, the optical combiner is able to move farther, faster, and more reliably into its breakaway position than possible with existing system.

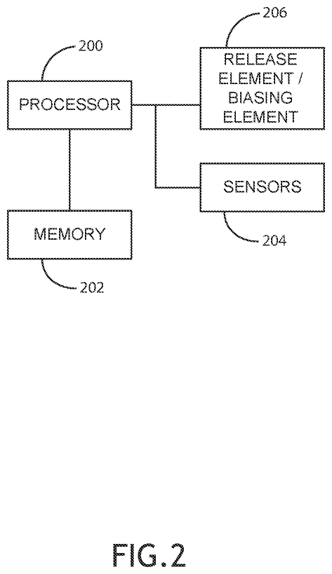

Referring to FIG. 2, a system suitable for implementing an exemplary embodiment is shown. The system may include a processor 200 configured to receive signals from a sensor 204. Based on the signals, the processor 200 directly actuates a biasing element/actuates a release element 206 to force the optical combiner into a safe orientation.

In at least one embodiment, the biasing element 206 may comprise an electric solenoid, an expanding gas mixture (e.g. sodium azide (NaN₃), KNO₃, and SiO₂), an electromagnet, or a motor/servo. In such embodiments, the processor 200 may directly actuate the biasing element 206. Alternatively, biasing element may comprise a mechanical energy storage device with a release element 206 including an electrical component (such as an electromagnet, motor/servo, or electric solenoid), a chemical component (such as a pyrotechnic bolt or expanding gas mixture), or a physical component (such as a weighted pendulum, spring, or compressed gas cylinder). In such embodiments, the processor 200 may actuate the release element.

In at least one embodiment, the sensor 204 may comprise an accelerometer, ultrasonic or optical distance sensor, or the like. Furthermore, the processor 200 may comprise a field programmable gate array or other solid-state system. Alternatively, the processor 200 may comprise a general purpose processor configured via non-transitory code stored in a memory 202.

An active breakaway mechanism with a reliable release system would improve overall design flexibility, pilot safety in a crash event, and reduce the risk of HIC test failure when introducing new designs or updates, enabling easier certification of future HUD systems.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A combiner element comprising:
a biasing element; and
a release element,
wherein:
the biasing element is configured to actively transition the combiner from an operational state to a safe state;
the release element is configured to retain the combiner in the operational state until a crash event is detected; and
when a crash event is detected, the release element is configured to release the combiner and the biasing element is configured to actively transition the combiner to the safe state.

2. The combiner element of claim 1, wherein the biasing element is a spring.

3. The combiner element of claim 1, wherein the biasing element is a compressed gas cylinder.

4. The combiner element of claim 1, wherein the biasing element is an electromagnet.

5. The combiner element of claim 1, wherein the biasing element is an electric solenoid.

6. The combiner element of claim 1, wherein the biasing element is an expanding gas element.

7. The combiner element of claim 1, wherein the release element is an electromagnet.

8. A combiner breakaway mechanism comprising:
a biasing element; and
a release element,
wherein:
the biasing element is configured to actively transition the combiner from an operational state to a safe state via a stored energy method;
the release element is configured to retain the combiner in the operational state until a crash event is detected; and
when a crash event is detected, the release element is configured to release the combiner and the biasing element is configured to actively transition the combiner to the safe state.

9. The combiner breakaway mechanism of claim 8, wherein the biasing element is a spring.

10. The combiner breakaway mechanism of claim 8, wherein the biasing element is a compressed gas cylinder.

11. The combiner breakaway mechanism of claim 8, wherein the biasing element is an electromagnet.

12. The combiner breakaway mechanism of claim 8, wherein the biasing element is an electric solenoid.

13. The combiner breakaway mechanism of claim 8, wherein the biasing element is a pyrotechnic device.

14. The combiner breakaway mechanism of claim 8, wherein the biasing element is a hydraulic actuator.

15. An aircraft helmet comprising:
a combiner with a breakaway mechanism comprising:
a biasing element;
a release element; and
at least one processor configured via non-transitory processor executable code,
wherein:
the biasing element is configured to actively transition the combiner from an operational state to a safe state; and
the at least one processor is configured to:
detect a crash event:
actuate the biasing element when a crash event is detected.

16. The aircraft helmet of claim 15, further comprising an accelerometer configured to detect a crash event, wherein the at least one processor is configured to detect the crash event via the accelerometer.

17. The aircraft helmet of claim 15, wherein the biasing element is a compressed gas cylinder.

18. The aircraft helmet of claim 15, wherein the biasing element is an electric solenoid.

19. The aircraft helmet of claim 15, wherein:
the release element is configured to retain the combiner in the operational state until a crash event is detected; and
the at least one processor is configured to actuate the release element when a crash event is detected.

20. The aircraft helmet of claim 15, wherein the release element is an electromagnet.
